(19) United States
(12) Patent Application Publication
(10) Pub. No.: US 2013/0107220 A1
(43) Pub. Date: May 2, 2013

(54) PROJECTOR, LIGHT SOURCE DEVICE, METHOD OF CONTROLLING TEMPERATURE OF LIGHT SOURCE, AND PROGRAM

(71) Applicant: Sony Corporation, Tokyo (JP)

(72) Inventor: Akio Furukawa, Saitama (JP)

(73) Assignee: SONY CORPORATION, Tokyo (JP)

(21) Appl. No.: 13/660,451

(22) Filed: Oct. 25, 2012

(30) Foreign Application Priority Data
Oct. 31, 2011 (JP) 2011-239756

(51) Int. Cl. G03B 21/16; F21V 29/00; G03B 21/14

(52) U.S. Cl. 353/20; 353/52; 315/117

(57) ABSTRACT

A projector includes a light source, a temperature adjustment mechanism, a memory, and a temperature controller. The light source is configured to emit light for displaying an image. The temperature adjustment mechanism is configured to adjust a temperature of the light source. The memory is configured to store an image to be displayed, before the image is displayed. The temperature controller is configured to determine a temporal change in brightness of the image to be displayed, based on the image to be displayed that is stored in the memory, and control the temperature of the light source by the temperature adjustment mechanism based on the temporal change in brightness of the image to be displayed, before the image to be displayed is actually displayed and the brightness of the image is changed.

### CROSS REFERENCES TO RELATED APPLICATIONS

The present application claims priority to Japanese Priority Patent Application JP 2011-239756 filed in the Japan Patent Office on Oct. 31, 2011, the entire content of which is hereby incorporated by reference.

### BACKGROUND

The present disclosure relates to the technology including a projector and the like that project an image on a screen or the like.

Generally, a high-pressure mercury lamp, a xenon lamp, a laser device, an LED (Light Emitting Diode), and the like are each used for a light source of a projector. The light source of the projector is expected to have a high light density and generates a large amount of heat when emitting light. Thus, the projector is generally provided with a mechanism for cooling the light source (see, for example, Japanese Patent Application Laid-open No. 2010-271556 (paragraphs [0017] to [0019], FIG. 1)).

The projector disclosed in Japanese Patent Application Laid-open No. 2010-271556 includes a radiator that comes into contact with an LED as a light source, a fan that sends air to the radiator and the light source, a temperature sensor that detects the temperature of the light source, and a control circuit that monitors the temperature of the light source and controls an air-cooling fan so that the temperature of the light source does not exceed a predetermined temperature.

### SUMMARY

Light source characteristics such as a luminance and a lifetime of the light source depend on the temperature of the light source. For example, a drastic change of the temperature of the light source decreases the luminance of the light source or shortens the lifetime of the light source. Thus, the temperature of the light source is desirably constant as much as possible.

Causes of the change in temperature of the light source are roughly divided into two. One of them resides in a change in temperature of an environment where the projector is placed, and the other one resides in a change in amount of light that is absorbed in the projector and converted into heat without being used for display.

The change in environmental temperature is gentle and a change range thereof is relatively small. Thus, a method of monitoring a temperature sensor in related art also copes with the change in environmental temperature.

However, the amount of light that is absorbed in the projector and converted into heat without being used for display may be abruptly changed. For example, when a state where an all-white image is displayed is switched to a state where an all-black image is displayed, the amount of light that is converted into heat without being used for display is abruptly increased. In such a case, in the method of monitoring the temperature sensor in related art, a timing at which the light source is cooled is delayed, which makes it difficult to maintain a constant temperature of the light source. In this case, the luminance of the light source is decreased and the lifetime of the light source is shortened.

In view of the circumstances as described above, it is desirable to provide the technology including a projector and the like that are capable of maintaining a constant temperature of a light source even when the amount of light that is absorbed in the projector and converted into heat without being used for display is changed.

According to an embodiment of the present disclosure, there is provided a projector including a light source, a temperature adjustment mechanism, a memory, and a temperature controller.

The light source is configured to emit light for displaying an image.

The temperature adjustment mechanism is configured to adjust a temperature of the light source.

The memory is configured to store an image to be displayed, before the image is displayed.

The temperature controller is configured to determine a temporal change in brightness of the image to be displayed, based on the image to be displayed that is stored in the memory, and control the temperature of the light source by the temperature adjustment mechanism based on the temporal change in brightness of the image to be displayed, before the image to be displayed is actually displayed and the brightness of the image is changed.

In this projector, the temperature of the light source is controlled based on the temporal change in brightness of the image to be displayed, before the image is actually displayed and the brightness of the image is changed. Thus, the temperature of the light source is controlled before the image is actually displayed, the brightness of the image is then changed, and accordingly the temperature of the light source is changed due to the change in amount of light that is absorbed in the projector and converted into heat without being used for display. Thus, even when the amount of light that is absorbed in the projector and converted into heat without being used for display is changed, a constant temperature of the light source is maintained. As a result, it is possible to prevent the decrease in luminance of the light source and shortening of the lifetime of the light source.

In the projector, the temperature controller may control the temperature of the light source to be decreased before the image is actually displayed in a case where the brightness of the image to be displayed is decreased.

With this structure, the temperature of the light source may be decreased before the brightness of the image is decreased and the temperature of the light source is raised due to an increase in amount of light that is converted into heat without being used for display. Thus, a constant temperature of the light source is maintained.

In the projector, the temperature controller may control the temperature of the light source to be raised before the image is actually displayed in a case where the brightness of the image to be displayed is increased.

With this structure, the temperature of the light source may be raised before the brightness of the image is increased and the temperature of the light source is decreased due to a decrease in amount of light that is converted into heat without being used for display. Thus, a constant temperature of the light source is maintained.

The projector may further include a reflective liquid crystal panel and a polarization beam splitter.

The polarization beam splitter is configured to guide, out of light from the light source, light in a specific polarization direction to the reflective liquid crystal panel, transmit, out of light that has been entered the reflective liquid crystal panel and reflected with the polarization direction thereof being modulated and light that has been reflected with the polarization direction thereof not being modulated, the light that has been reflected with the polarization direction thereof being modulated, and return the light that has been reflected with the polarization direction thereof not being modulated to the light source.

In this projector, the light reflected with the polarization direction thereof not being modulated by the reflective liquid crystal panel is returned to the light source by the polarization beam splitter. In the case of this projector, the temperature of the light source is changed by being largely affected due to the change in brightness of the image. Thus, in the case where the projector includes the reflective liquid crystal panel and the polarization beam splitter, the temperature control as described above (temperature control performed before the image is actually displayed and the brightness of the image is changed) is particularly effective.

In the projector, the light source may include one of a laser device and a light-emitting diode.

In the case where the light source is a laser device or a light-emitting diode, light source characteristics such as the luminance, the lifetime, and the like of the light source are easily affected by the change in temperature of the light source. Thus, in the case where the light source is a laser device or a light-emitting diode, the temperature control as described above (temperature control performed before the image is actually displayed and the brightness of the image is changed) is particularly effective.

According to another embodiment of the present disclosure, there is provided a light source device including a light source, a temperature adjustment mechanism, a memory, and a temperature controller.

The light source is configured to emit light for displaying an image.

The temperature adjustment mechanism is configured to adjust a temperature of the light source.

The memory is configured to store an image to be displayed, before the image is displayed.

The temperature controller is configured to determine a temporal change in brightness of the image to be displayed, based on the image to be displayed that is stored in the memory, and control the temperature of the light source by the temperature adjustment mechanism based on the temporal change in brightness of the image to be displayed, before the image is actually displayed and the brightness of the image is changed.

According to another embodiment of the present disclosure, there is provided a method of controlling a temperature of a light source, the method including: storing an image to be displayed in a memory before the image is displayed; determining a temporal change in brightness of the image to be displayed, based on the image to be displayed that is stored in the memory; and controlling a temperature of a light source for displaying the image, based on the temporal change in brightness of the image to be displayed, before the image to be displayed is actually displayed and the brightness of the image is changed.

According to another embodiment of the present disclosure, there is provided a program causing a projector to execute: storing an image to be displayed in a memory before the image is displayed; determining a temporal change in brightness of the image to be displayed, based on the image to be displayed that is stored in the memory; and controlling a temperature of a light source for displaying the image, based on the temporal change in brightness of the image to be displayed, before the image to be displayed is actually displayed and the brightness of the image is changed.

As described above, according to the present disclosure, it is possible to provide the technology including a projector and the like that are capable of maintaining a constant temperature of a light source even when the amount of light that is absorbed in the projector and converted into heat without being used for display is changed.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic diagram showing a projector according to an embodiment of the present disclosure;

FIG. 2 is a flowchart of the operation of the projector;

FIGS. 3A, 3B, 3C, and 3D are diagrams showing a relationship among a change in average luminance value of image data, an amount of light absorbed without being used for display, and a temperature of a light source; and

FIGS. 4A, 4B, 4C, and 4D are diagrams each showing a period of time in which a temperature controller is capable of calculating (estimating) a change in average luminance value.

### DETAILED DESCRIPTION

Hereinafter, an embodiment of the present disclosure will be described with reference to the drawings.

[Overall Structure of Projector 100 and Structures of Respective Units]

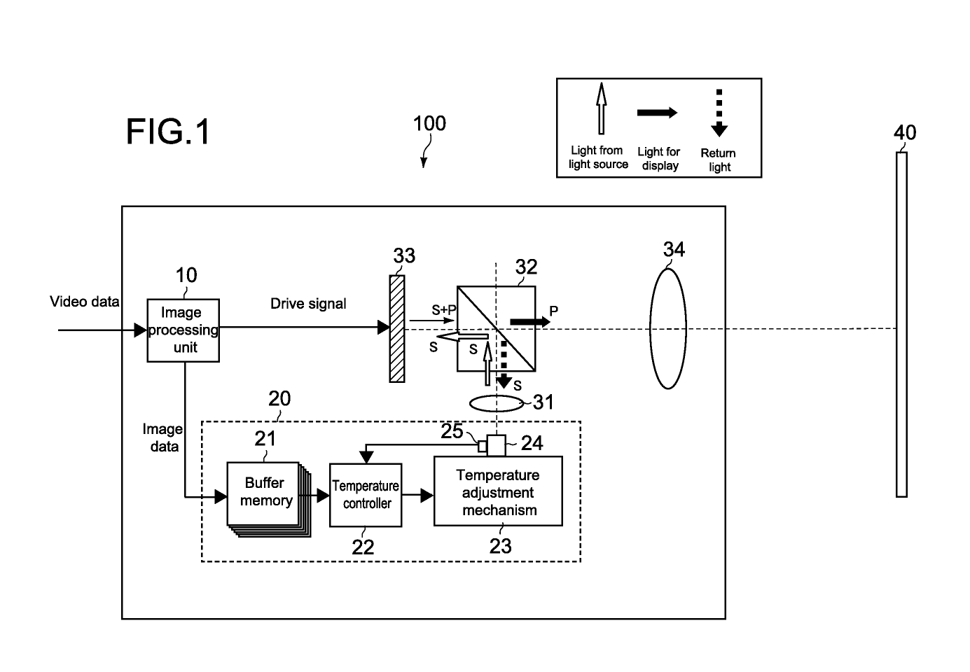

FIG. 1 is a schematic diagram showing a projector 100 according to this embodiment.

As shown in FIG. 1, the projector 100 includes an image processing unit 10, a light source device 20 including a light source 24, a focusing optical system 31, a polarization beam splitter (PBS) 32, a reflective liquid crystal panel 33, and a projection lens 34.

The light source device 20 includes the light source 24, a plurality of buffer memories 21, a temperature controller 22, a temperature adjustment mechanism 23, and a temperature sensor 25.

The image processing unit 10 receives video data from a video-data storage device. Then, the image processing unit 10 generates a drive signal based on the received video data and outputs the drive signal to the reflective liquid crystal panel 33. Further, the image processing unit 10 outputs image data corresponding to the video data to the buffer memories 21.

The light source 24 emits light for displaying an image. Examples of the light source 24 include a high-pressure mercury lamp, a xenon lamp, a laser device, and a light-emitting diode (LED).

For simple illustration, FIG. 1 shows a single lens as the focusing optical system 31. However, the focusing optical system 31 may include a light integrator constituted of fly-eye lenses, a polarization conversion optical system constituted of a PBS thin film, a mirror, and the like, in addition to the single lens.

The light integrator uniforms an uneven light flux output from the light source 24. The polarization conversion optical system aligns non-polarized light output from the light source 24 in a specific polarization direction (S-polarization).

The polarization beam splitter 32 reflects light in a specific polarization direction and transmits light in a polarization direction other than the above polarization direction. For example, the polarization beam splitter 32 reflects light of S-polarization and transmits light of a polarization direction other than the S-polarization, i.e., light of P-polarization. The polarization beam splitter 32 reflects light that has been output from the light source 24 and aligned in the S-polarization by the polarization optical system and guides the light to the reflective liquid crystal panel 33.

The reflective liquid crystal panel 33 applies a voltage to a specific pixel based on the drive signal from the image processing unit 10. The reflective liquid crystal panel 33 modulates, in the pixel to which the voltage is applied, the polarization direction of the light entering from the beam splitter side by use of a voltage value corresponding to the brightness of the pixel (modulates S-polarized light to be mixed light of S-polarized light and P-polarized light) and then reflects the light. The light is modulated to be mixed light that includes more P-polarization components in bright pixels and more S-polarization components in dark pixels. Therefore, in principle, the light reflected by the reflective liquid crystal panel 33 becomes mixed light of S-polarized light and P-polarized light.

It should be noted that when a voltage value corresponding to a maximum brightness is applied to all pixels of the reflective liquid crystal panel 33, the light reflected on the reflective liquid crystal panel 33 is almost only P-polarized light. On the other hand, when a voltage value corresponding to a minimum brightness is applied to all the pixels of the reflective liquid crystal panel 33, the light reflected on the reflective liquid crystal panel 33 is almost only S-polarized light.

The reflective liquid crystal panel 33 is of a 1-chip type or a 3-chip type. In the 1-chip type, a single reflective liquid crystal panel 33 is commonly used for R, G, and B, and R, G, and B are extracted from white light by time sharing. In the 3-chip type, a total of three reflective liquid crystal panels 33 are used for each of colors of R, G, and B.

In FIG. 1, the case of adopting the 1-chip type as the type of the reflective liquid crystal panel 33 is shown, but any of the 1-chip type and the 3-chip type may be used as the type of the reflective liquid crystal panel 33. As the light source, any type of a light source that divides white light source into three colors of R, G, and B and a light source that uses three independent light sources for R, G, and B may be used. It should be noted that when the 3-chip type and the white light source are adopted, the projector 100 is additionally provided with a cross dichroic mirror that splits white light into three colors of R, G, and B and guides the split three-color light to the reflective liquid crystal panels 33 for the respective colors, and the like.

Of P-polarized light reflected with the polarization direction thereof being modulated by the reflective liquid crystal panel 33 and S-polarized light reflected with the polarization direction thereof not being modulated, the polarization beam splitter 32 transmits the P-polarized light reflected with the polarization direction thereof being modulated. The P-polarized light transmitted through the polarization beam splitter 32 becomes display light. This display light is projected on a screen 40 via the projection lens 34. Thus, an image corresponding to the video data is displayed on the screen 40.

Meanwhile, the polarization beam splitter 32 returns, to the light source 24, the S-polarized light that is reflected with the polarization direction thereof not being modulated. The light returned to the light source 24 by the polarization beam splitter 32 becomes return light. When the brightness (luminance value) of the image displayed on the screen 40 changes, the amount of the return light is changed. With the change in amount of the return light, the temperature of the light source 24 is changed.

For example, it is assumed that a state where an all-white image is displayed on the screen 40 is switched to a state where an all-black image is displayed thereon. When an all-white image is displayed, almost all of the S-polarized light that has been output from the light source 24 and then reflected on the polarization beam splitter 32 is modulated to be P-polarized light in the reflective liquid crystal panel 33. The resultant P-polarized light is transmitted through the polarization beam splitter 32 and projected on the screen 40. In this case, return light that is reflected on the polarization beam splitter 32 and then returned to the light source 24 scarcely exist.

On the other hand, when the state where an all-white image is displayed is switched to the state where an all-black image is displayed, the S-polarized light that has been output from the light source 24 and then reflected on the polarization beam splitter 32 is not modulated in the reflective liquid crystal panel 33, and almost all of the S-polarized light is reflected as it is. Almost all of the S-polarized light is reflected on the polarization beam splitter 32 and returned to the light source 24. The return light becomes a cause of the temperature rise of the light source 24.

In this manner, the temperature of the light source 24 is affected by the brightness (luminance value) of an image to be displayed.

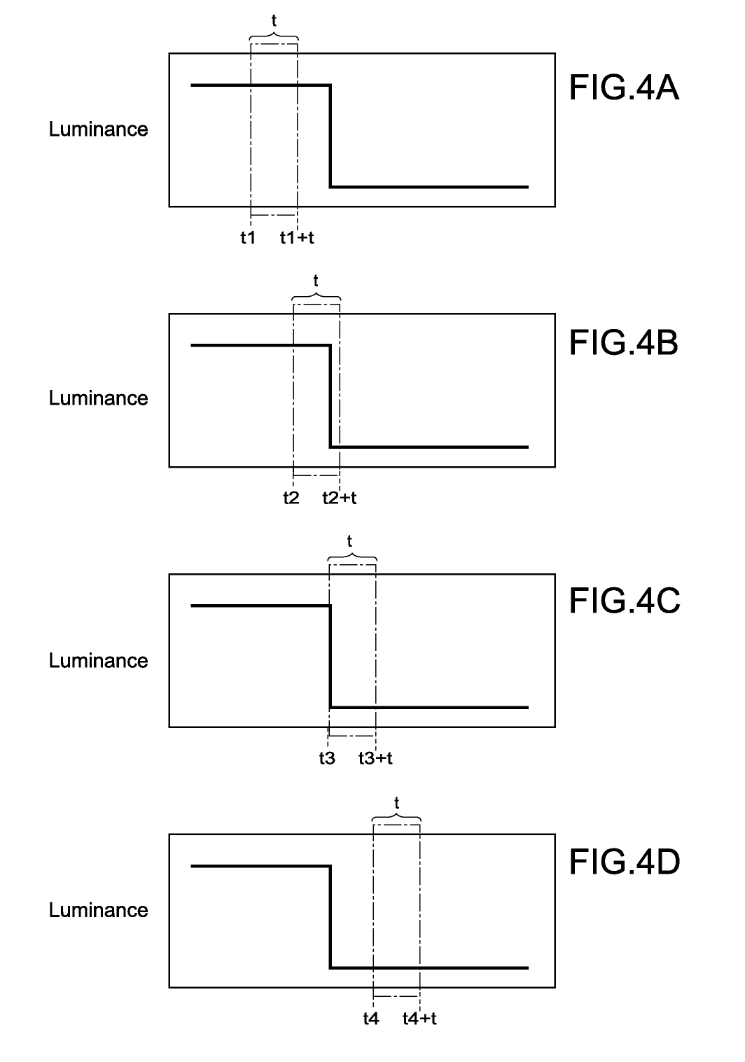

The plurality of buffer memories 21 receive and store image data to be displayed by the projector from the image processing unit 10 before images is displayed. The plurality of buffer memories 21 are capable of storing images that are to be displayed in a period of time between a current time and a time t seconds after the current time. The time t is, for example, about several seconds to several tens of seconds (see FIG. 4). Each of the buffer memories 21 stores image data corresponding to one image (one frame), for example.

The buffer memories 21 are each a volatile memory. In the case where all the buffer memories 21 are fully used to store image data, the oldest image data (image data already displayed) is deleted from the buffer memories 21, and image data newly received from the image processing unit 10 is stored in the buffer memories 21.

The temperature controller 22 reads, from the buffer memories 21, image data to be displayed (image data to be displayed in a period of time between the current time and the time t seconds after the current time) and calculates an average luminance value (brightness) of the image data for each image. Then, the temperature controller 22 determines a temporal change in average luminance value of the image data to be displayed.

Before the image data to be displayed is actually displayed and then the average luminance value (brightness) of the image data is changed, the temperature controller 22 adjusts the temperature of the light source 24 by the temperature adjustment mechanism 23 based on the temporal change in average luminance value. In other words, before the average luminance value of the image data is changed, the amount of the return light is changed, and then the temperature of the light source 24 is changed, the temperature controller 22 adjusts the temperature of the light source 24 by the temperature adjustment mechanism 23. The processing of the temperature controller 22 will be described later in detail.

The temperature adjustment mechanism 23 is a mechanism for adjusting the temperature of the light source 24, and is configured to adjust the temperature of the light source 24 under the control of the temperature controller 22. The temperature adjustment mechanism 23 includes, for example, a heat link that comes into contact with the light source 24, and a fan that generates an atmospheric current toward a heat sink and the light source 24. Alternatively, the temperature adjustment mechanism 23 may be a temperature adjustment mechanism 23 using a Peltier element. The temperature adjustment mechanism 23 may have any structure as long as it is capable of adjusting the temperature of the light source 24 under the control of the temperature controller 22.

The temperature sensor 25 outputs a signal corresponding to the temperature of the light source 24 to the temperature controller 22. The temperature sensor 25 is, for example, a thermocouple or a measuring resistor. The type of the temperature sensor 25 is not particularly limited.

The projector 100 includes a storage device (not shown) including a non-volatile memory (for example, ROM (Read Only memory)) and the like. The storage device fixedly stores various programs necessary for the processing of the image processing unit 10 and the temperature controller 22. The various programs may be read from portable recording media such as an optical disc and a semiconductor memory.

[Description on Operation]

Next, the operation of the projector 100 will be described.

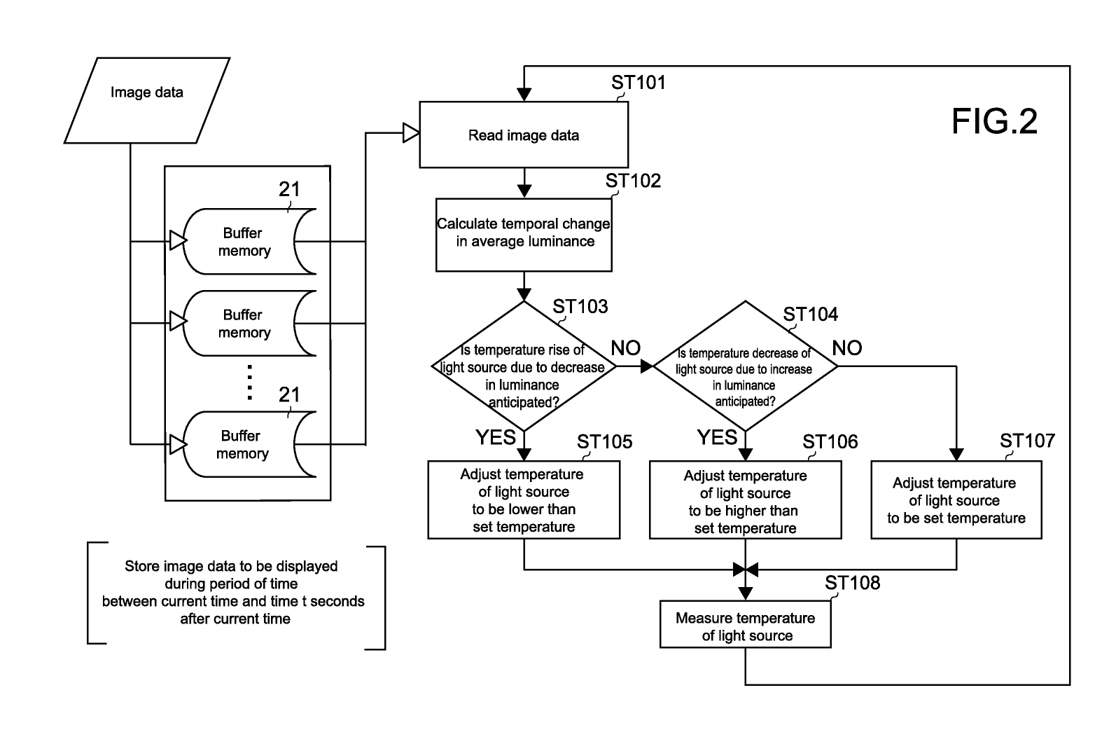

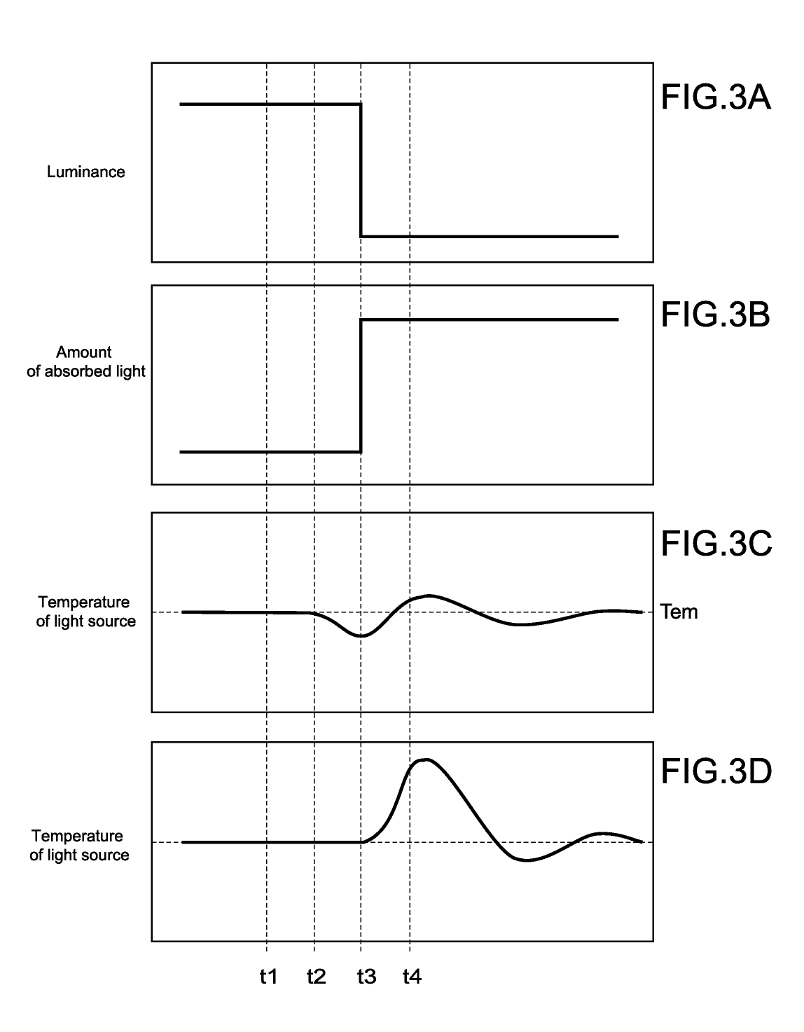

FIG. 2 is a flowchart of the operation of the projector 100. FIGS. 3A, 3B, 3C, and 3D are diagrams showing a relationship among a change in average luminance value of image data, an amount of light absorbed without being used for display, and a temperature of the light source 24.

As shown in FIG. 2, the plurality of buffer memories 21 receive and store image data to be displayed from the image processing unit 10 before the image data is displayed. The plurality of buffer memories 21 store image data that is to be displayed in a period of time between a current time and a time t seconds after the current time. Each of the buffer memories 21 stores image data corresponding to one image (one frame).

The temperature controller 22 first reads image data from each of the buffer memories 21 (Step 101). The temperature controller 22 then calculates an average luminance value of the entire image for each of images corresponding to the read image data.

Next, the temperature controller 22 calculates a temporal change in average luminance value of the image data (Step 102). FIG. 3A shows an example of a temporal change in average luminance value. FIG. 3A shows an example in which at a time t3, the state where an all-white image is displayed is switched to the state where an all-black image is displayed. In other words, FIG. 3A shows an example in which the average luminance value of the image data is abruptly decreased at the time t3.

As described above, the plurality of buffer memories 21 store the image data that is to be displayed in the period of time between the current time and the time t seconds after the current time. Accordingly, in Step 102, the temperature controller 22 calculates (estimates) a temporal change in average luminance value of the image data in the period of time between the current time and the time t seconds after the current time.

FIGS. 4A, 4B, 4C, and 4D are diagrams each showing a period of time during which the temperature controller 22 is capable of calculating (estimating) a change in average luminance value. FIGS. 4A, 4B, 4C, and 4D show a period of time during which a change in average luminance value is estimated at times t1, t2, t3, and t4, respectively (see dashed lines).

For example, with reference to FIG. 4A, at the time t1, the temperature controller 22 obtains a temporal change (waveform) in average luminance value in a period of time between the time t1 and a time t1+t.

With reference to FIG. 3, FIG. 3B shows an example of a change in amount of light that is absorbed in the projector 100 and converted into heat without being used for displaying an image. As shown in FIG. 3B, the change in amount of the light that is absorbed in the projector 100 and converted into heat has a waveform opposite to that of the change in average luminance value of the image data shown in FIG. 3A.

In other words, as shown in FIG. 3A, when the average luminance value of the image data is abruptly decreased at the time t3, as shown in FIG. 3B, the amount of light that is absorbed in the projector 100 and converted into heat increases abruptly at the time t3. In this case, since the temperature inside the projector 100 rises, which leads to the temperature rise of the light source 24.

Here, since the projector 100 according to this embodiment has the structure in which the reflective liquid crystal panel 33 and the polarization beam splitter 32 are used, the light not used for display is directly returned to the light source 24. Accordingly, the temperature of the light source 24 is easily affected by the change in average luminance value of the image data.

Referring back to FIG. 2, after calculating the temporal change in average luminance value, the temperature controller 22 determines whether the temperature of the light source 24 will rise due to a decrease in average luminance value in the period of time between the current time and the time t seconds after the current time (Step 103). In this case, the temperature controller 22 determines whether the temperature rise of the light source 24 is anticipated based on the temporal change in average luminance value in the period of time described above (see dashed lines of FIG. 4).

For example, in the case where the average luminance value is abruptly decreased (see FIG. 4B) or gradually decreased in the period of time described above, the temperature controller 22 determines that the temperature of the light source 24 will rise.

On the other hand, for example, it is assumed that the average luminance values of most image data items are substantially constant and only some image data items have low (dark) average luminance values in the period of time described above. In this case, at a time point at which the image data items having low average luminance values exist, the average luminance values are momentarily decreased, but the average luminance values are immediately increased. Accordingly, in the case where the average luminance values of the image data are momentarily decreased, the temperature rise of the light source 24 that is caused due to the decrease in average luminance value hardly occurs. Therefore, in such a case, the temperature controller 22 may determine that the temperature rise of the light source 24 due to the decrease in average luminance value will not be caused.

In the case where the temperature rise of the light source 24 due to the decrease in average luminance value is anticipated in the period of time described above (YES in Step 103), the temperature controller 22 adjusts the temperature of the light source 24 to be lower than a set temperature Tem (see FIG. 3C) (Step 105). In this case, the temperature controller 22 controls the temperature adjustment mechanism 23 such as a fan or a Peltier element to cool the light source 24, to thereby adjust the temperature of the light source 24. After adjusting the temperature of the light source 24, the temperature controller 22 acquires the temperature of the light source 24 from the temperature sensor 25, to thereby measure the temperature of the light source 24 (Step 108).

Here, to what extent the temperature of the light source 24 is made lower than the set temperature Tem will be described. The decreased range of the temperature of the light source 24 is set based on the gradient of the change in average luminance value and the range of the change in average luminance value. For example, the decreased range of the temperature of the light source 24 is set to be larger in the case where the gradient of the change in average luminance value is sharp than in the case where the gradient of the change in average luminance value is gentle. Further, for example, the decreased range of the temperature of the light source 24 is set to be larger in the case where the range of the change in average luminance value is large than in the case where the range of the change in average luminance value is small. It should be noted that the gradient of the change in average luminance value, the range of the change in average luminance value, and the decreased range of the temperature of the light source 24 are associated with one another and tabulated to be stored in the storage device.

On the other hand, when it is determined in Step 103 that the temperature rise of the light source 24 due to the decrease in average luminance value is not anticipated (NO in Step 103), the temperature controller 22 proceeds to Step 104. In Step 104, the temperature controller 22 determines whether the temperature of the light source 24 will decrease due to an increase in average luminance value in the period of time between the current time and the time t seconds after the current time (Step 104). In this case, the temperature controller 22 determines whether the temperature decrease of the light source 24 is anticipated based on the temporal change in average luminance value in the period of time described above as in Step 103.

For example, in the case where the average luminance value is abruptly raised or gradually raised in the period of time described above, the temperature controller 22 determines that the temperature of the light source 24 will decrease. This is because a cooling level, at which the temperature of the light source is maintained to be the set temperature in a low average luminance state, becomes excess when the average luminance is increased.

On the other hand, for example, it is assumed that the average luminance values of most image data items are substantially constant and only some image data items have high (bright) average luminance values in the period of time described above. In this case, at a time point at which the image data items having high average luminance values exist, the average luminance values are momentarily increased, but the average luminance values are immediately decreased. Accordingly, the temperature decrease of the light source 24 that is caused due to the increase in average luminance value hardly occurs. Therefore, in such a case, the temperature controller 22 may determine that the temperature decrease of the light source 24 due to the increase in average luminance value will not be caused.

In the case where the temperature decrease of the light source 24 due to the increase in average luminance value is anticipated in the period of time described above (YES in Step 104), the temperature controller 22 adjusts the temperature of the light source 24 to be higher than the set temperature Tem (see FIG. 3C) (Step 106). In this case, the temperature controller 22 controls the temperature adjustment mechanism 23 such as the fan or the Peltier element to adjust the temperature of the light source 24.

For example, in the case where the temperature adjustment mechanism 23 is the fan, the temperature controller 22 raises the temperature of the light source 24 by decreasing the number of rotations of the fan being driven or stopping the fan. Further, for example, in the case where the temperature adjustment mechanism 23 is the Peltier element, the temperature controller 22 raises the temperature of the light source 24 by stopping the drive of the Peltier element, changing the magnitude of a current flowing in the Peltier element, or inverting the direction of the current flowing in the Peltier element to be opposite to the direction at the time of cooling.

After adjusting the temperature of the light source 24, the temperature controller 22 acquires the temperature of the light source 24 from the temperature sensor 25 to measure the temperature of the light source 24 (Step 108).

The raised range of the temperature of the light source 24 is set based on the gradient of the change in average luminance value and the range of the change in average luminance value. For example, the raised range of the temperature of the light source 24 is set to be larger in the case where the gradient of the change in average luminance value is sharp than in the case where the gradient of the change in average luminance value is gentle. Further, for example, the raised range of the temperature of the light source 24 is set to be larger in the case where the range of the change in average luminance value is large than in the case where the range of the change in average luminance value is small.

On the other hand, when it is determined in Step 104 that the temperature decrease of the light source 24 due to the increase in average luminance value is not anticipated (NO in Step 104), the temperature controller 22 proceeds to Step 107. In other words, it is determined that neither the temperature rise nor the temperature decrease of the light source 24 are anticipated, the temperature controller 22 proceeds to Step 107.

For example, in the case where the average luminance value is almost not changed and substantially constant in the period of time described above, it is determined that neither the temperature rise nor the temperature decrease of the light source 24 are anticipated (see FIGS. 4A, 4C, and 4D). Further, for example, in the case where the average luminance values of most image data items are substantially constant and only some image data items have different average luminance values in the period of time described above, it is determined that neither the temperature rise nor the temperature decrease of the light source 24 are anticipated.

In Step 107, the temperature controller 22 controls the temperature adjustment mechanism 23 to adjust the temperature of the light source 24 to be the set temperature Tem (see FIG. 3C). Then, the temperature controller 22 acquires the temperature of the light source 24 from the temperature sensor 25 to measure the temperature of the light source 24 (Step 108).

After measuring the temperature of the light source 24, the temperature controller 22 returns to Step 101 and reads again image data from the plurality of buffer memories 21. The image data read from the plurality of buffer memories 21 at this time is different from the image data that has been read from the buffer memories 21 one loop before. Specifically, the image data already displayed is deleted from the buffer memories 21 and image data newly received from the image processing unit 10 is stored in the buffer memories 21 anew, and accordingly image data to be read at this time is different from the image data that has been read one loop before.

After reading image data from the plurality of buffer memories 21, the temperature controller 22 calculates an average luminance value of the image data for each image as in the same manner as described above and then calculates a temporal change in average luminance value (Step 102). Then, the temperature controller 22 executes the processing of Step 103 and the following steps. After that, the processing of Step 101 to Step 108 is repeated.

FIG. 3C shows a change in temperature of the light source 24 when the processing shown in FIG. 2 is executed in the case where the average luminance value of the image data is abruptly decreased (see FIG. 3A) and the amount of light absorbed in the projector 100 is abruptly increased (see FIG. 3B).

A state where the temperature of the light source 24 is changed as shown in FIG. 3C when the processing shown in FIG. 2 is executed will be specifically described with reference to FIG. 4.

With reference to FIG. 4A, at the time t1, the temperature controller 22 calculates the change in average luminance value of the image data in the period of time between the current time t1 and the time t1+t (Steps 101 to 102). In this period of time, the average luminance value of the image data is almost not changed and is substantially constant, and accordingly the temperature controller 22 determines that neither the temperature rise nor the temperature decrease of the light source 24 due to the change in average luminance value are anticipated (NO in Step 103 to NO in Step 104). In this case, the temperature controller 22 controls the temperature adjustment mechanism 23 to adjust the temperature of the light source 24 to be the set temperature Tem (Step 107).

With reference to FIG. 4B, at the time t2, the temperature controller 22 calculates the change in average luminance value of the image data in a period of time between the current time t2 and a time t2+t (Steps 101 to 102). In this period of time, the average luminance value of the image data is abruptly decreased, and accordingly the temperature controller 22 determines that the temperature rise of the light source 24 due to the decrease in average luminance value of the image data is anticipated (YES in Step 103).

In this case, the temperature controller 22 controls the temperature adjustment mechanism 23 to adjust the temperature of the light source 24 to be lower than the set temperature Tem (Step 105). At the time t2, the temperature controller 22 starts controlling the temperature of the light source 24 to be lower than the set temperature Tem.

The temperature controller 22 determines that the temperature rise of the light source 24 due to the decrease in average luminance value of the image data is anticipated in a period of time between the time t2 and the time t3, and controls the temperature adjustment mechanism 23 to cool the light source 24, which corresponds to the loop of Step 101 to YES in Step 103 and to Step 108.

With reference to FIG. 4C, at the time t3, the temperature controller 22 calculates the change in average luminance value of the image data in a period of time between the current time t3 and a time t3+t (Steps 101 to 102). In this period of time, the average luminance value of the image data is almost not changed and is substantially constant, and accordingly the temperature controller 22 determines that neither the temperature rise nor the temperature decrease of the light source 24 due to the change in average luminance value are anticipated (NO in Step 103 to NO in Step 104).

In this case, the temperature controller 22 controls the temperature adjustment mechanism 23 to adjust the temperature of the light source 24 to be the set temperature Tem (Step 107). Accordingly, at the time t3, the temperature controller 22 terminates the control of adjusting the temperature of the light source 24 to be lower than the set temperature Tem.

With reference to FIG. 4D, at a time t4, the temperature controller 22 calculates the change in average luminance value of the image data in a period of time between the current time t4 and a time t4+t (Steps 101 to 102). In this period of time, the average luminance value of the image data is almost not changed and is substantially constant, and accordingly the temperature controller 22 determines that neither the temperature rise nor the temperature decrease of the light source 24 due to the change in average luminance value are anticipated (NO in Step 103 to NO in Step 104). In this case, the temperature controller 22 controls the temperature adjustment mechanism 23 to adjust the temperature of the light source 24 to be the set temperature Tem (Step 107).

As described above, the temperature controller 22 determines that the temperature rise of the light source 24 due to the decrease in average luminance value of the image data is anticipated in the period of time between the time t2 and the time t3, and controls the temperature adjustment mechanism 23 to cool the light source 24. In other words, the temperature controller 22 decreases the temperature of the light source 24 from the time point of the time t2 before the time t3 at which the temperature of the light source 24 is raised due to the decrease in average luminance value of the image data.

With this operation, as shown in FIG. 3C, even if the temperature of the light source 24 starts increasing at the time t3 due to the influence caused by the change in average luminance value, the increase of the temperature of the light source 24 is suppressed because the temperature of the light source 24 is already set to be lower than the set temperature Tem. In other words, the projector 100 according to this embodiment maintains a constant temperature of the light source 24. As a result, in this embodiment, it is possible to prevent the decrease in luminance of the light source 24 and shortening of the lifetime of the light source 24.

Here, with reference to FIG. 3D, a description will be given of a change in temperature of a light source 24 in the case where the temperature of the light source 24 is controlled by a projector according to Comparative Example. In a projector 100 according to Comparative Example, a method of controlling the temperature of the light source 24 by acquiring temperature information from a temperature sensor 25 provided to the light source 24 and monitoring the temperature of the light source 24 is used.

In the projector according to Comparative Example, the temperature rise is detected after a short period of time has elapsed from the time t3. Then, when the temperature rise of the light source 24 is detected, such control as to decrease the temperature of the light source 24 is executed. Therefore, a timing at which the light source 24 is cooled is delayed, with the result that the temperature of the light source 24 is largely raised as shown in FIG. 3D. The temperature of the light source 24 is often raised by 10° C. or more. In this manner, if the temperature of the light source 24 is largely changed, the luminance of the light source 24 is decreased and the lifetime of the light source 24 is shortened.

On the other hand, in this embodiment, the temperature of the light source 24 is kept constant as described above, and therefore it is possible to prevent the decrease in luminance of the light source 24 and shortening of the lifetime of the light source 24.

Further, in this embodiment, the reflective liquid crystal panel 33 and the polarization beam splitter 32 are used so that light that is not to be used for display is directly returned to the light source 24. Thus, the temperature of the light source 24 is easily affected by the change in average luminance value of the image data. Therefore, in the case where the projector 100 includes the reflective liquid crystal panel 33 and the polarization beam splitter 32, it is particularly effective to execute the processing as described above. It should be noted that the projector 100 does not necessarily include the reflective liquid crystal panel 33 and the like. The present disclosure is also applicable to, for example, a projector including a transmissive liquid crystal panel.

In the case where the light source 24 is a laser device or a light-emitting diode, light source characteristics such as the luminance, the lifetime, and the like of the light source 24 are easily affected by the change in temperature of the light source 24. Thus, in the case where the light source 24 is a laser device or a light-emitting diode, it is particularly effective to execute the processing as described above.

Hereinabove, there has been described the case where the average luminance value of the image data is changed by one level in the period of time between the current time and the time t seconds after the current time. On the other hand, actually, the average luminance value of the image data is continuously changed in the period of time over several times. Thus, in such a case, the control in consideration of the change of a plurality of average luminance values allows effective temperature control.

The present disclosure may take the following structures.

(1) A projector, including:

a light source configured to emit light for displaying an image;

a temperature adjustment mechanism configured to adjust a temperature of the light source;

a memory configured to store an image to be displayed, before the image is displayed; and

a temperature controller configured to determine a temporal change in brightness of the image to be displayed, based on the image to be displayed that is stored in the memory, and control the temperature of the light source by the temperature adjustment mechanism based on the temporal change in brightness of the image to be displayed, before the image to be displayed is actually displayed and the brightness of the image is changed.

(2) The projector according to (1), in which

the temperature controller controls the temperature of the light source to be decreased before the image is actually displayed in a case where the brightness of the image to be displayed is decreased.

(3) The projector according to (1) or (2), in which

the temperature controller controls the temperature of the light source to be raised before the image is actually displayed in a case where the brightness of the image to be displayed is increased.

(4) The projector according to any one of (1) to (3), further including:

a reflective liquid crystal panel; and

a polarization beam splitter configured to guide, out of light from the light source, light in a specific polarization direction to the reflective liquid crystal panel, transmit, out of light that has been entered the reflective liquid crystal panel and reflected with the polarization direction thereof being modulated and light that has been reflected with the polarization direction thereof not being modulated, the light that has been reflected with the polarization direction thereof being modulated, and return the light that has been reflected with the polarization direction thereof not being modulated to the light source.

(5) The projector according to any one of (1) to (4), in which

the light source includes one of a laser device and a light-emitting diode.

(6) A light source device, including:

a light source configured to emit light for displaying an image;

a temperature adjustment mechanism configured to adjust a temperature of the light source;

a memory configured to store an image to be displayed, before the image is displayed; and

a temperature controller configured to determine a temporal change in brightness of the image to be displayed, based on the image to be displayed that is stored in the memory, and control the temperature of the light source by the temperature adjustment mechanism based on the temporal change in brightness of the image to be displayed, before the image is actually displayed and the brightness of the image is changed.

(7) A method of controlling a temperature of a light source, the method including:

storing an image to be displayed in a memory before the image is displayed;

determining a temporal change in brightness of the image to be displayed, based on the image to be displayed that is stored in the memory; and

controlling a temperature of a light source for displaying the image, based on the temporal change in brightness of the image to be displayed, before the image to be displayed is actually displayed and the brightness of the image is changed.

(8) A program causing a projector to execute:

storing an image to be displayed in a memory before the image is displayed;

determining a temporal change in brightness of the image to be displayed, based on the image to be displayed that is stored in the memory; and

controlling a temperature of a light source for displaying the image, based on the temporal change in brightness of the image to be displayed, before the image to be displayed is actually displayed and the brightness of the image is changed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A projector, comprising:
a light source configured to emit light for displaying an image;
a temperature adjustment mechanism configured to adjust a temperature of the light source;
a memory configured to store an image to be displayed, before the image is displayed; and
a temperature controller configured to determine a temporal change in brightness of the image to be displayed, based on the image to be displayed that is stored in the memory, and control the temperature of the light source by the temperature adjustment mechanism based on the temporal change in brightness of the image to be displayed, before the image to be displayed is actually displayed and the brightness of the image is changed.

2. The projector according to claim 1, wherein
the temperature controller controls the temperature of the light source to be decreased before the image is actually displayed in a case where the brightness of the image to be displayed is decreased.

3. The projector according to claim 1, wherein
the temperature controller controls the temperature of the light source to be raised before the image is actually displayed in a case where the brightness of the image to be displayed is increased.

4. The projector according to claim 1, further comprising:
a reflective liquid crystal panel; and
a polarization beam splitter configured to guide, out of light from the light source, light in a specific polarization direction to the reflective liquid crystal panel, transmit, out of light that has been entered the reflective liquid crystal panel and reflected with the polarization direction thereof being modulated and light that has been reflected with the polarization direction thereof not being modulated, the light that has been reflected with the polarization direction thereof being modulated, and return the light that has been reflected with the polarization direction thereof not being modulated to the light source.

5. The projector according to claim 1, wherein
the light source includes one of a laser device and a light-emitting diode.

6. A light source device, comprising:
a light source configured to emit light for displaying an image;
a temperature adjustment mechanism configured to adjust a temperature of the light source;
a memory configured to store an image to be displayed, before the image is displayed; and
a temperature controller configured to determine a temporal change in brightness of the image to be displayed, based on the image to be displayed that is stored in the memory, and control the temperature of the light source by the temperature adjustment mechanism based on the temporal change in brightness of the image to be displayed, before the image is actually displayed and the brightness of the image is changed.

7. A method of controlling a temperature of a light source, the method comprising:
storing an image to be displayed in a memory before the image is displayed;
determining a temporal change in brightness of the image to be displayed, based on the image to be displayed that is stored in the memory; and
controlling a temperature of a light source for displaying the image, based on the temporal change in brightness of the image to be displayed, before the image to be displayed is actually displayed and the brightness of the image is changed.

8. A program causing a projector to execute:
storing an image to be displayed in a memory before the image is displayed;
determining a temporal change in brightness of the image to be displayed, based on the image to be displayed that is stored in the memory; and
controlling a temperature of a light source for displaying the image, based on the temporal change in brightness of the image to be displayed, before the image to be displayed is actually displayed and the brightness of the image is changed.
